(19) United States
(12) Patent Application Publication
(10) Pub. No.: US 2017/0139313 A1
(43) Pub. Date: May 18, 2017

(54) VIVARIUM DRY AND LIQUID PROJECTION

(71) Applicant: Heidi Lynn Turner, Long Beach, CA (US)

(72) Inventor: Heidi Lynn Turner, Long Beach, CA (US)

(21) Appl. No.: 14/945,387

(22) Filed: Nov. 18, 2015

(51) Int. Cl. G03B 21/28; G03B 21/14

(52) U.S. Cl. CPC G03B 21/28; G03B 21/145; G03B 21/147

(57) ABSTRACT

A projection apparatus for projection inside a vivarium environment (101) comprises a display member (107) and a projection surface (108) adapted to be positioned inside the dry or liquid environment within the vivarium (101) and a projector (104) positioned outside the vivarium environment (102) where at least part of one wall of the vivarium enclosure is transparent. The projector (104) is adapted to be positioned on its narrow edge and project an image on the projection surface utilizing a highly reflective surface (105) to redirect the projection and an additional lens, or lenses, (106) to further refine the image.

### CROSS-REFERENCE TO RELATED APPLICATIONS

Not Applicable

### FEDERALLY SPONSORED RESEARCH

Not Applicable

### JOINT RESEARCH AGREEMENT

Not Applicable

### SEQUENCE LISTING OR PROGRAM

Not Applicable

### PRIOR DISCLOSURES BY THE INVENTOR OR A JOINT INVENTOR

Not Applicable

### BACKGROUND OF THE INVENTION

Field of Invention

The present disclosure is directed toward projection systems and methods of use, and more particularly to systems and methods for projection inside a dry or liquid vivarium environment.

Prior Art

As used herein, the term vivarium is defined as an enclosed area for keeping and raising animals or plants for enjoyment, observation or research. Often, a portion of the ecosystem for a particular species is simulated on a smaller scale, with controls for environmental conditions. There are various forms of vivarium, including: aquarium, insectarium, terrarium, paludarium, and riparium.

Modern image projection systems are designed to project larger images and require distance to function, a common throw ratio being 2/1 (for each foot of image width, the projector must be 2 feet away). Even short throw projectors, which are designed for closer projection, require space to focus properly and again the goal is to project a larger image. Anyone in possession of a projector can suspend it from the ceiling or set it up at on an adjacent horizontal surface and point it towards their vivarium; however, front projection can be easily disrupted by human activity outside the enclosure and the projected images tend to be too large to be integrated with vivarium decor items. Typical home vivariums are wall mounted, positioned against a wall, or inside of cabinetry with only a shallow space left vacant for cleaning and environmental controls. This makes it difficult to project from the top, rear, or sides into the enclosure. Setting up a projection display, utilizing a common multi-purpose projector in these tight spaces is challenging, if even possible.

The use of a reflective surface to direct light goes back to antiquity and technology has often utilized the qualities of reflection. For example, the use of a reflective surface to redirect a projected image has been a common feature of overhead projectors for decades. U.S. Pat. No. 2,603,125 to Alfred Evers filed Aug. 16, 1949 discloses an overhead projector which is a combination enlarger and projector system that utilizes lenses and a reflector assembly to convert the direction of the projection. Modern overhead projectors still utilize this feature, but it has not been adapted for use with modern multi-use projectors.

U.S. Pat. Pub. App. No. 20140078409 to Jiansheng Wang filed Sep. 14, 2012 describes a projection apparatus where both the projection display surface and projector are inside a liquid environment. Locating the projector inside the vivarium creates issues with heat and noise that require additional mechanisms to combat. In fact, heat dissipation inside of a vivarium could increase the temperature and do injury to the inhabitants. Locating the projector inside the vivarium also creates issues with power availability and, in the case of liquid environments, shielding to separate electricity and water. Wang also suggests the use of an underwater projector powered by battery which would probably reduce the heat produced through operation, but, removing the projector to replace spent batteries would impact the vivarium environment as well.

U.S. Pat. Pub. App. No. 20060231041 to Richard K. Bilow filed Jun. 15, 2006 discloses a multimedia habitat assembly that involves an image-revealing window connected with a confined habitat structure and includes an image display system to allow for visual media to be displayed as a backdrop to the elements of nature also being displayed. The viewing window is positioned opposite from the image-revealing window such that the visual media can be seen through the viewing window. The intention is to restrict viewers from seeing the interior of the confined habitat while observing the image-revealing window through the viewing window. The image-revealing window itself is clear so that a monitor or projection can be viewed through it. Alternatively the image-revealing window itself is a screen. Regardless, when a projector is used in an embodiment of this disclosure, the image is projected onto the rear wall (wall opposite the viewing window) from behind the habitat, and not into the habitat environment. The habitat assembly also does not solve the problem of limited space to the rear and sides of the habitat for projection.

U.S. Pat. Pub. App. No. 20130215394 and 20150153634 to Reddy, Johnson, and Doyle with No. 20130215394 filed Jun. 26, 2012 and No. 20150153634 filed Feb. 10, 2015 discloses underwater image projection systems where the inventors address distortion issues associated with underwater projection. Both systems include a module for correction of the visual image projected. More importantly, Reddy, Johnson, and Doyle elected to position the projector inside of a liquid enclosure in both systems.

### OBJECTS AND ADVANTAGES

Modern multi-use projectors function in different ways but have similarities. The projection begins with a powerful light. The light is then processed in a variety of ways before it is output through a lens or lenses to the viewing screen. The function of the projector generally dictates that the plane of the projection is not the narrowest edge of the projector. The present invention includes a projector support apparatus that allows a standard multi-use projector to be operated while standing on its narrow edge. This greatly reduces the space needed around the perimeter of the enclosure to set up a projection display. The support apparatus incorporates a highly reflective surface to redirect the projection onto the projection surface within the vivarium. An additional lens, or lenses, can also be installed to the projector support to further focus the image on the projection surface which tends to be smaller and at a shorter distance than even short throw projectors are designed to facilitate. The additional lenses can be useful to correctly size the image output of various projectors for vivarium decor items. The additional lenses can also work to overcome the loss of image clarity due to the projection passing though matter with different indices of refraction, such as glass and water. I have found magnification lenses to be very effective.

Positioning the projector outside the vivarium enclosure is preferable as it does not impact the vivarium ecosystem. Any heat and/or noise generated by the projector are located outside the enclosure, and therefore no threat to the vivarium inhabitants. A lack of power availability inside the vivarium is also a non-issue when a standard multi-use projector is located outside the enclosure, as is the potential for electric shock, especially in a liquid environment.

There exists a need for a low profile projection apparatus for projection in a dry and liquid vivarium environment. Further objects and advantages of my projection apparatus will become apparent from a consideration of the drawings and ensuing description.

### SUMMARY

The present invention, as claimed, is a projection apparatus for projection in a dry or liquid vivarium environment. The projection apparatus comprising: a projection surface adapted to be positioned in the vivarium environment; and a projector positioned outside the vivarium environment where at least part of one wall of the vivarium enclosure is transparent and wherein the projector is adapted to be positioned in a narrow space and project an image on the projection surface utilizing a highly reflective surface to redirect the projection and an additional lens, or lenses, to further resize and refine the image for projection at close range.

### DRAWINGS—FIGURES

FIG. 1 is a side view of a vivarium projection system according to one or more embodiments of the disclosure.

### REFERENCE NUMERALS

101 Vivarium Environment
102 Area External to Vivarium Environment
103 Projector Support Apparatus
104 Projector
105 Highly Reflective Surface
106 Lens
107 Display Member
108 Projection Surface
109 Power Supply
110 Power Cable

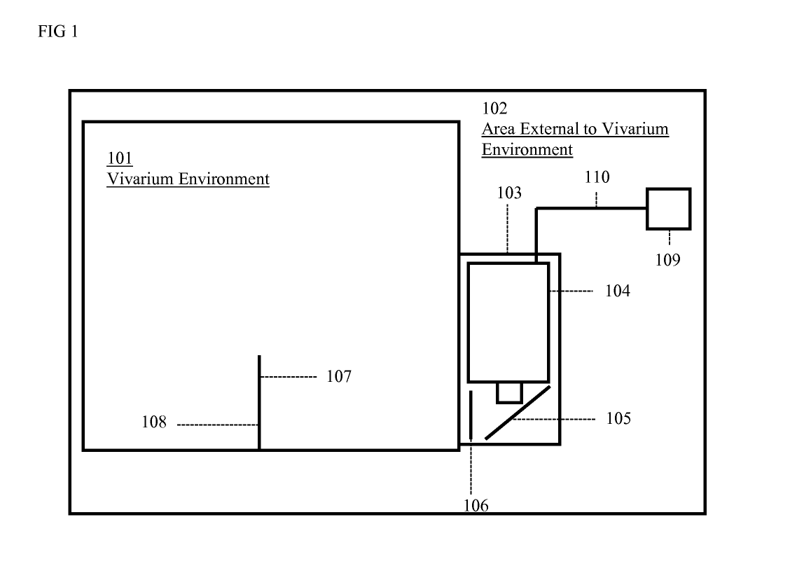

### DETAILED DESCRIPTION—FIG. 1-PREFERRED EMBODIMENT

The following disclosure provides many different embodiments, or examples, for implementing different features of the disclosure. Specific examples of components and arrangements are described below to simplify the present disclosure. These are, of course, merely examples and are not intended to be limiting.

Referring now to FIG. 1, an apparatus for vivarium environment projection is illustrated according to an embodiment of the present disclosure. The apparatus includes a vivarium projection display member 107 and a projection surface 108 inside the Vivarium environment 101. The area external to vivarium environment 102 includes a projector support apparatus 103 that contains a projector 104, a highly reflective surface 105, and an additional lens 106 for projecting an image on to the projection surface 108. The projector support 103 may be attached to the vivarium, hung from an edge, rest on a horizontal surface, or be held in proximity with the vivarium by any other method.

As shown in FIG. 1, the projection display portions of the apparatus 107 and 108 are installed inside the dry or liquid vivarium environment 101. Suitable liquids may include, for example, fresh water or, salt water. Generally, the liquid may be clear but colored liquids or liquids containing suspended solid particles may also be suitable. The projection display member 107 may be a clear substrate such as glass or plastic. Alternatively, the projection display member 107 may be a wall of the vivarium enclosure. Other suitable projection display member 107 materials may include textiles, wood, plastic, fiberglass, metal, inorganic material (e.g., stone, ceramic) or a combination of materials. In various embodiment, the projection surface 108 may be chemically treated to repel or block liquids.

As shown in FIG. 1, the projection surface 108 inside the vivarium environment 101, faces the projector 104 located in the area external to vivarium environment 102 and receives an image (e.g., still image, video image) which may be a two- or three-dimensional image from the projector 104. The projector 104 may be any form of an image projector including, for example, an image projector such as a video or still image projector. As most vivariums are, by necessity, positioned against a wall or inside furniture, the projector 104 is installed on its narrow edge to reduce its profile and fit easily in a narrow space. The projector 104 uses the reflective surface 105 to transmit an image toward the projection surface 108. An Additional lens or multiple lenses 106 may be used to properly focus the image on the projection surface 108. The additional lens, or lenses, 106 may be included in the projector support 103 as shown in FIG. 1. Alternatively the additional lens, or lenses, 106 may be positioned inside the vivarium environment 101.

The projector 104 includes a light source, such a light bulb or a LED bulb, an image converter, and a plurality of lenses. The projector 104 may include a computer or is connected to a computer providing a digitized image to the image converter. A light generated from the light source may be projected to the image converter, therein the digitized image is converted to an optical image, and then is projected (focused) on the projection surface 108. The projector support 103 may include an enclosure or shield that prevents liquid from accidentally accessing components of the projector 104 that would be damaged by liquid when used to project into a liquid environment. Alternatively the projector 104 may have sealed components to make the projector generally impervious to liquid. The projector 104 may be connected to a power supply 109 via a power cord 110 located outside of the vivarium environment 102.

The apparatus may be used for dry or liquid vivarium projection in furtherance of any variety of purposes. For example, vivarium projection systems may provide information into the vivarium environment for use in education, entertainment, or research activities. In general, the vivarium environment projection systems may display images in a dry or liquid environment and enhance viewer experiences and capabilities for both humans and animals. Thus, vivarium projection systems may influence the viewer's experience. For example, educational uses may include displaying how to protect oceans in coral reef area or showing background information of exhibits in a public vivarium display.

Entertainment uses for the apparatus may include allowing a viewer to experience the addition of fantasy creatures living amongst the living inhabitants of the vivarium or generating other interesting art effects. Fantasy creatures could include, for example, prehistoric animals or fictional creatures assumed to never have existed in nature.

Projecting images may also allow researchers to communicate with and study animals in the vivarium environment. Research uses for the apparatus could include, for example, the study of responses or relationships of living creatures with their prey or predators by projecting these images within the vivarium. The apparatus may also be used, for example, to attract underwater and terrestrial creatures in the vivarium environment. For example, the apparatus may be used to display bait, coaxing reticent creatures out for viewing and display.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

### CONCLUSION, RAMIFICATIONS, AND SCOPE

Thus the reader will see that the projection apparatus of the invention provides a low profile, projection device for vivarium environments. The projector location outside of the vivarium environment minimizes the ecological impact to the ecosystem inside. Also, the location of the power supply outside of the vivarium environment is especially beneficial when the environment is liquid.

While the above description contains many specificities, these should not be construed as limitations on the scope of the invention, but rather as an exemplification of one preferred embodiment thereof. Many other variations are possible. For example the projection display member is intended to have aesthetic appeal and could be designed in an unlimited number of materials, shapes, colors, and sizes. Also, an additional lens or lenses beyond those included in the construction of the projector may be necessary to reduce the size of the projected image and focus the image at close range. These lenses may be included inside or outside of the vivarium environment, or omitted all together. Furthermore, the optical components of the projector support could be integrated into the projector itself. It is also it is important to note that the projection apparatus can function in any situation where limited space is a factor and does not require the presence of a vivarium. Accordingly, the scope of the invention should be determined not by the embodiment illustrated, but by the appended claims and their legal equivalents.

I claim:

1. A projection apparatus comprising:
(a) a projection surface, and
(b) a projector adapted to be positioned on its narrow edge and project an image on said projection surface.

2. The projection apparatus of claim 1 wherein said projection surface is incorporated into vivarium decor.

3. The projection apparatus of claim 1 wherein said projection surface is a front or side wall of the vivarium.

4. The projection apparatus of claim 1 wherein said projector is adapted to be positioned on its narrow edge using a projector support.

5. The projection apparatus of claim 4 wherein said projector support includes a highly reflective surface to direct the projection toward said projection surface.

6. The projection apparatus of claim 4 wherein said projector support includes an additional lens to modify the projection image.

7. The projection apparatus of claim 4 wherein said projector support includes additional lenses to modify the projection image.

8. The projection apparatus of claim 5 wherein said highly reflective surface is a mirror.

9. A method of projecting an image in a vivarium environment, the method comprising:
(a) providing a projection surface adapted to be positioned inside the vivarium environment, and
(b) providing a projector adapted to be positioned on its narrow edge outside the vivarium environment and project an image on said projection surface.

10. The method of claim 9 further comprising: providing a projector support to position said projector on its narrow edge.

11. The method of claim 10 further comprising: providing a highly reflective surface to redirect the projection toward said projection surface.

12. The method of claim 10 further comprising: providing an additional lens to modify the projection image.

13. The method of claim 10 further comprising: providing additional lenses to modify the projection image.
